(19) United States
(12) Patent Application Publication
(10) Pub. No.: US 2026/0194852 A1
(43) Pub. Date: Jul. 9, 2026

(54) POWER SUPPLY CIRCUIT AND PRINTING APPARATUS

(71) Applicant: KYOCERA Document Solutions Inc., Osaka (JP)

(72) Inventor: Masayuki SHIGETOMI, Osaka (JP)

(73) Assignee: KYOCERA Document Solutions Inc., Osaka (JP)

(21) Appl. No.: 19/440,369

(22) Filed: Jan. 5, 2026

(30) Foreign Application Priority Data
Jan. 7, 2025 (JP) 2025-002395

(51) Int. Cl. G03G 15/00

(52) U.S. Cl. CPC G03G 15/80; G03G 15/5004

(57) ABSTRACT

A power supply circuit according to the present disclosure includes a voltage monitoring part and a voltage adjusting part. The voltage monitoring part is configured to monitor an input voltage of a DC-DC (Direct Current-Direct Current) converter. The voltage adjusting part is configured to adjust an output voltage of the DC-DC converter by increasing the output voltage of the DC-DC converter when the input voltage falls below a reference voltage at a time of transition from a normal mode to a power-saving mode.

### INCORPORATION BY REFERENCE

This application is based on and claims the benefit of priority from Japanese patent application No. 2025-002395 filed on Jan. 7, 2025, which is incorporated by reference in its entirety.

### BACKGROUND

The present disclosure relates to a power supply circuit and a printing apparatus.

### BACKGROUND

An image forming apparatus includes an AC-DC (Alternating Current-Direct Current) converter for converting AC (Alternating Current) power supplied from a commercial power source into DC (Direct Current) power, and a DC-DC (Direct Current-Direct Current) converter for converting the DC power obtained from the AC-DC converter into DC power at a voltage suitable for each load circuit. The load circuit includes, for example, a charging device, an exposure device, a developing device, a transfer device, a fixing device, a sheet conveying device, and a control device and the like in the case where the image forming apparatus is an apparatus that forms images using an electrophotographic method.

### SUMMARY

A power supply circuit according to the present disclosure includes a voltage monitoring part and a voltage adjusting part. The voltage monitoring part is configured to monitor an input voltage of a DC-DC (Direct Current-Direct Current) converter. The voltage adjusting part is configured to adjust an output voltage of the DC-DC converter by increasing the output voltage of the DC-DC converter when the input voltage falls below a reference voltage at a time of transition from a normal mode to a power-saving mode.

A printing apparatus according to the present disclosure is configured to print on a sheet. The printing apparatus includes a load circuit and a power supply circuit. The load circuit is configured to control or operate the printing apparatus. The power supply circuit includes a DC-DC (Direct Current-Direct Current) converter and a voltage adjusting part. The DC-DC converter is configured to output a voltage to the load circuit. The voltage adjusting part is configured to adjust an output voltage which is a voltage output from the DC-DC converter so that, when an input voltage which is a voltage input to the DC-DC converter is lower than a predetermined reference voltage, a voltage difference between the input voltage and the output voltage is reduced compared to before adjustment.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of a printing apparatus according to one embodiment of the present disclosure.

FIG. 2 is a right side view schematically showing an internal structure of the printing apparatus according to the embodiment of the present disclosure.

FIG. 3 is a circuit diagram showing a power supply circuit according to the embodiment of the present disclosure.

FIG. 4 is a timing diagram showing a control procedure for the power supply circuit according to the embodiment of the present disclosure.

FIG. 5A is a diagram showing an example of total power consumption before and after increasing a voltage applied to a semiconductor at the time of transition to power-saving mode according to the embodiment of the present disclosure.

FIG. 5B is a diagram showing another example of the total power consumption before and after increasing the voltage applied to the semiconductor at the time of transition to the power-saving mode according to the embodiment of the present disclosure.

### DETAILED DESCRIPTION

Hereinafter, with reference to the drawings, a printing apparatus 1 according to one embodiment of the present disclosure will be described.

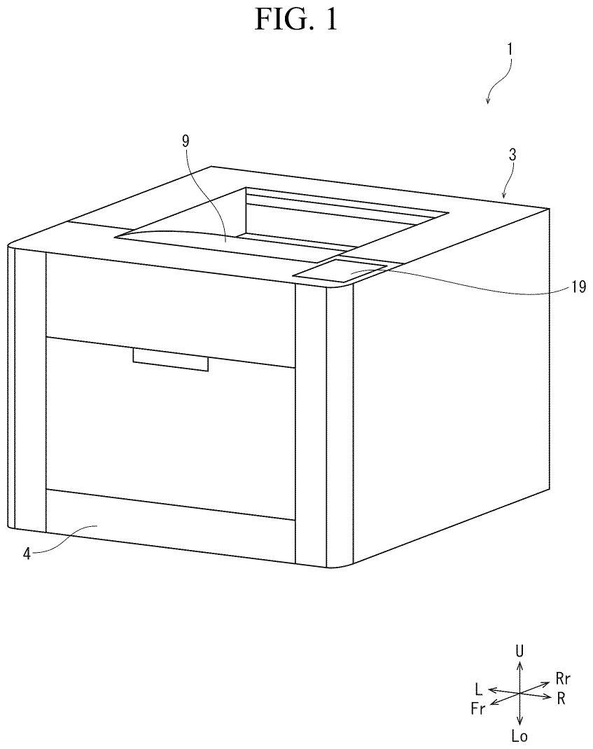

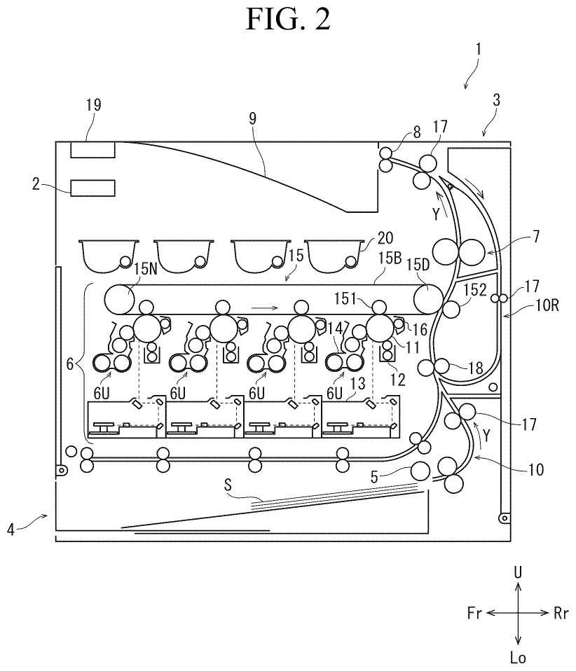

FIG. 1 is a perspective view showing an appearance of the printing apparatus 1. FIG. 2 is a right side view schematically showing an internal structure of the printing apparatus 1. In each figure, U, Lo, L, R, Fr, and Rr indicate the upper, lower, left, right, front, and rear, respectively. These directions are determined only for convenience of explanation.

The printing apparatus 1 (see FIG. 1 and FIG. 2) includes a rectangular parallelepiped body housing 3. In the lower portion of the inside of the body housing 3, a sheet feeding cassette 4 in which a sheet S is stored and a sheet feeding roller 5 which feeds the sheet S rearward from the sheet feeding cassette 4 are provided. Above the sheet feeding cassette 4, an image forming device 6 which forms a toner image by an electrophotographic method is provided, and a fixing device 7 which fixes the toner image to the sheet S is provided above and on the rear side of the image forming device 6. Above the fixing device 7, a discharge roller 8 which discharges the sheet S on which the toner image is fixed and a discharge tray 9 on which the discharged sheet S is stacked are provided.

Inside the body housing 3, a conveying path 10 is provided from the sheet feeding roller 5 through the image forming device 6 and the fixing device 7 to the discharge roller 8. The conveying path 10 is formed mainly of plate-like members facing each other with a gap for passing the sheet S, and conveying rollers 17 for holding and conveying the sheet S are provided at a plurality of positions in the conveying direction Y. A registration roller 18 is provided on the upstream side of the image forming device 6 in the conveying direction Y. An inversion conveying path 10R is provided on the rear side of the fixing device 7. The inversion conveying path 10R branches from the conveying path 10 at a branch point positioned on the downstream side of the fixing device 7 in the conveying direction Y, and merges with the conveying path 10 at a merging point positioned on the upstream side of the registration roller 18 in the conveying direction Y.

The image forming device 6 includes four sets of image forming units 6U and an intermediate transfer unit 15. The image forming unit 6U is provided with a photosensitive drum 11 whose potential changes by irradiation with light, a charging device 12 which charges the photosensitive drum 11, and an exposure device 13 which emits a laser beam corresponding to image data. In addition, the image forming unit 6U is provided with a developing device 14 which supplies toner to the photosensitive drum 11 and a cleaning device 16 which removes the toner remaining on the photosensitive drum 11. The intermediate transfer unit 15 is provided with an endless intermediate transfer belt 15B wound around a driving roller 15D and a driven roller 15N. Furthermore, the intermediate transfer unit 15 is provided with a primary transfer roller 151 which faces the inner peripheral surface of the intermediate transfer belt 15B at a position corresponding to the photosensitive drum 11 and generates a primary transfer bias. In addition, the intermediate transfer unit 15 is provided with a secondary transfer roller 152 which faces the outer peripheral surface of the intermediate transfer belt 15B at a position corresponding to the driving roller 15D and generates a secondary transfer bias. A toner container 20 which supplies the toner to the developing device 14 is connected to the developing device 14. The image forming device 6 forms a color image by superposing toner images of four colors on the intermediate transfer belt 15B. The printing apparatus 1 may include two, three, or five or more sets of image forming units 6U.

A control part 2 includes an arithmetic part and a storage part (not shown). The arithmetic part is, for example, a CPU (Central Processing Unit). The storage part includes a storage medium such as ROM (Read Only Memory), RAM (Random Access Memory), and EEPROM (Electrically Erasable Programmable Read Only Memory) and the like. The arithmetic part executes various processes by reading and executing the control program stored in the storage part. Since the various processes include processes for controlling the printing apparatus 1, the arithmetic part is configured to control the printing apparatus 1 by executing the various processes. The control part 2 may be realized only by an integrated circuit without using software.

A display operation part 19 includes a display panel, a touch panel superposed on the display surface of the display panel, and a keypad. The control part 2 causes the display panel to display a screen showing an operation menu, a status, and the like of the printing apparatus 1 and controls each part of the printing apparatus 1 according to an operation detected by the touch panel and the keypad.

When a print job is inputted to the printing apparatus 1, the sheet feeding roller 5 feeds the sheet S from the sheet feeding cassette 4 to the conveying path 10. Next, the registration roller 18 whose rotation is stopped corrects the posture of the sheet S, and the registration roller 18 feeds the sheet S to the image forming device 6 at a predetermined timing. In the image forming device 6, the charging device 12 charges the photosensitive drum 11 to a predetermined potential, and the exposure device 13 writes an electrostatic latent image in the photosensitive drum 11. Thereafter, the developing device 14 forms a toner image by developing the electrostatic latent image using the toner supplied from the toner container 20. Thereafter, the primary transfer roller 151 transfers the toner image to the intermediate transfer belt 15B, and the secondary transfer roller 152 transfers the toner image to the sheet S.

Subsequently, the fixing device 7 fuses the toner image while holding and conveying the sheet S to fix the toner image to the sheet S, and the discharge roller 8 discharges the sheet S to the discharge tray 9. In the case of double-sided printing, the sheet S having the toner image fixed on the first surface is fed to the conveying path 10 via the inversion conveying path 10R, whereby the toner image is transferred to the second surface.

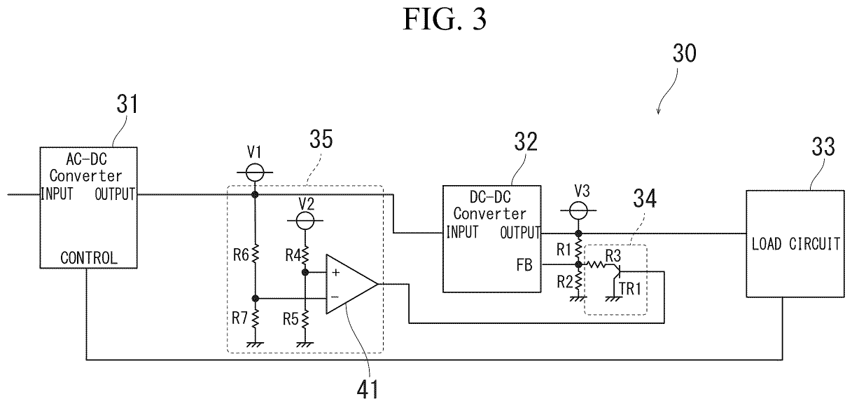

FIG. 3 is a circuit diagram showing a power supply circuit 30. The power supply circuit 30 includes an AC-DC converter 31 and a DC-DC converter 32, and supplies power generated by the DC-DC converter 32 to a load circuit 33. The AC-DC converter 31 converts AC power supplied from a commercial power source into DC power. The DC-DC converter 32 converts DC power obtained from the AC-DC converter into DC power at a voltage suitable for each load circuit 33. The load circuit 33 includes, in this embodiment where the printing apparatus 1 is an apparatus that prints images using the electrophotographic method, the motors (not shown) for driving the charging device 12, the exposure device 13, the developing device 14, the intermediate transfer unit 15, the fixing device 7, the conveying roller 17 and the others, as well as the control part 2 and the like.

A voltage adjusting part 34 which adjusts an output voltage V3 of the DC-DC converter 32 is connected to a FB terminal (feedback terminal) of the DC-DC converter 32, and the power supply circuit 30 adjusts the output voltage V3 of the DC-DC converter 32 depending on the voltage adjusting part 34 being ON or OFF. The voltage adjusting part 34 is composed of inexpensive devices such as resistors R1 to R3 and a transistor TR1.

Furthermore, a voltage monitoring part 35 which monitors an input voltage V1 of the DC-DC converter 32 is connected to an input terminal of the DC-DC converter 32, and the voltage monitoring part 35 transmits a change in the input voltage V1 of the DC-DC converter 32 to the voltage adjusting part 34.

The voltage monitoring part 35 monitors the input voltage V1 of the DC-DC converter 32 with a comparator 41. In the power-saving mode, when the input voltage V1 of the DC-DC converter 32 falls below a reference value, the transistor TR1 of the voltage adjusting part 34 is turned on, and the output voltage V3 rises. In the normal mode, when the input voltage V1 of the DC-DC converter 32 exceeds the reference value, the transistor TR1 of the voltage adjusting part 34 is turned off, and the output voltage V3 drops.

[Voltage Adjusting Part] The resistors R1 and R2 of the voltage adjusting part 34 are components constituting the DC-DC converter 32. The resistors R1 and R2 divide the output voltage V3, and apply the divided voltage to the FB terminal of the DC-DC converter 32, and compare the divided voltage with a reference voltage in the DC-DC converter 32 to adjust the output voltage V3 so that the voltage of the FB terminal becomes equal to the reference voltage. The resistor R3 becomes parallel to the resistor R2 when the transistor TR1 is turned on.

When the transistor TR1 is turned ON, the resistors R2 and R3 are parallel, and a combined resistance of the resistors R2 and R3 is smaller than the resistor R2. The DC-DC converter 32 increases the output voltage V3 so that the voltage of the FB terminal becomes equal to the internal reference voltage of the DC-DC converter 32. This operation reduces the input/output voltage difference of the DC-DC converter 32 and improves power efficiency.

On the other hand, when the transistor TR1 is turned OFF, since a GND side resistance value of the FB terminal becomes larger (R2>combined resistance R2 and R3) compared to when the transistor TR1 is turned ON, the DC-DC converter 32 drops the output voltage V3 so that the voltage of the FB terminal becomes equal to the internal reference voltage of the DC-DC converter 32.

The resistance values of the resistors R1 and R2 are determined when the DC-DC converter 32 is designed. Furthermore, the resistance values of the resistors R1 and R2 are generally set such that the value of the output voltage V3 from the DC-DC converter 32 is set to around the center value of the voltage range allowed by the load circuit 33. The resistance value of the resistor R3 is set such that the output voltage V3 is close to the upper limit voltage allowed by the load circuit 33 when the transistor TR1 is turned on. However, the resistance value of the resistor R3 must be set such that the value of the output voltage V3 does not exceed the value of the upper limit voltage of the load circuit 33 in consideration of variations in the resistors R1 and R2 and the internal reference voltages of the DC-DC converter 32.

[Voltage Monitoring Part] The resistors R4 and R5 of the voltage monitoring part 35 generate a reference voltage (COMP reference voltage) of the comparator 41 and apply the generated COMP reference voltage to the positive terminal of the comparator 41. The resistors R6 and R7 divide the input voltage V1 of the DC-DC converter 32 (COMP detection voltage) and apply the generated COMP detection voltage to the negative terminal of the comparator 41.

In the power-saving mode, the input voltage V1 of the DC-DC converter 32 drops to a predetermined voltage in the power-saving mode, and when the COMP detection voltage falls below the COMP reference voltage, the comparator 41 outputs high to turn on the transistor TR1.

In the normal mode, the input voltage V1 of the DC-DC converter 32 rises to a predetermined voltage in the normal mode, and when the COMP detection voltage exceeds the COMP reference voltage, the comparator 41 outputs low to turn off the transistor TR1.

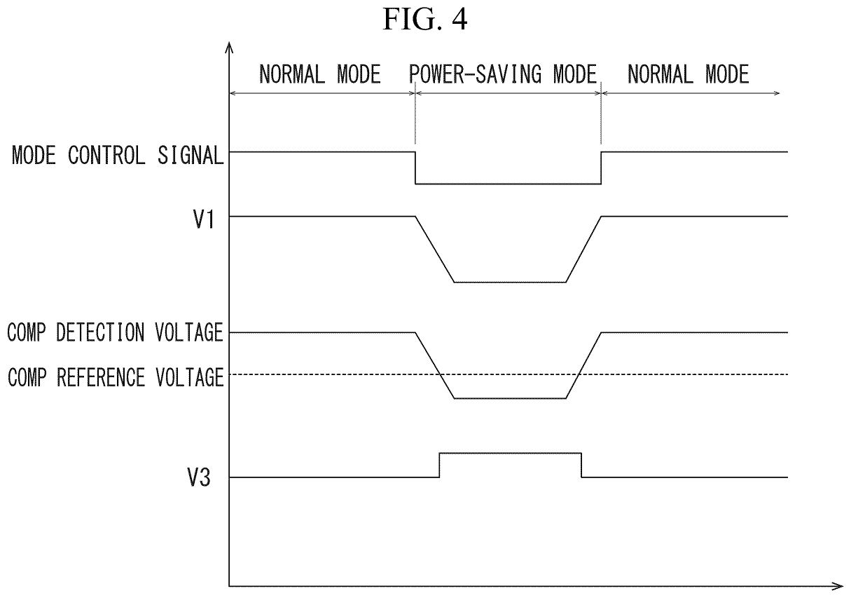

The resistance values of the resistors R4, R5, R6, and R7 are set to values that enable the above-described operations. Additionally, as the voltages V2 of the resistors R4 and R5 and the power supply (not shown) of the comparator 41, a power supply generated at a place not shown in the figure may be used, or the power supply of the output voltage V3 may be used.

[Control Procedure] FIG. 4 is a timing diagram showing a control procedure of the power supply circuit 30. When transitioning from the normal mode to the power-saving mode, a mode control signal indicating a transition to the power-saving mode is transmitted from the load circuit 33 to the control terminal of the AC-DC converter 31, and the input voltage V1 drops. Thereafter, when the COMP detection voltage falls below the COMP reference voltage, the transistor TR1 is turned on and the output voltage V3 rises.

On the other hand, when returning from the power-saving mode to the normal mode, a mode control signal indicating the return from the power-saving mode is transmitted from the load circuit 33 to the control terminal of the AC-DC converter 31, and the input voltage V1 rises. Thereafter, when the COMP detection voltage exceeds the COMP reference voltage, the transistor TR1 is turned off and the output voltage V3 drops.

Generally, the power consumption of a semiconductor increases when the voltage is increased. On the other hand, the efficiency of the DC-DC converter 32 improves as the input/output voltage difference becomes small, but this tendency becomes remarkable as the current consumed is small. Therefore, when the current consumed by the CPU or the like is small during the energy saving, the decrease in power due to the improvement in conversion efficiency of the DC-DC converter 32 may exceed the increase in power of the device due to the increase of the voltage. The present embodiment is suitable for such a case.

Leak current is one of the main power consumed by the semiconductor in the power-saving mode (a state in which the semiconductor is not operating much). The leakage current is caused by the CMOS structure inside the semiconductor, and it becomes larger as the process is miniaturized. The larger the circuit size in the semiconductor, the larger the leakage current.

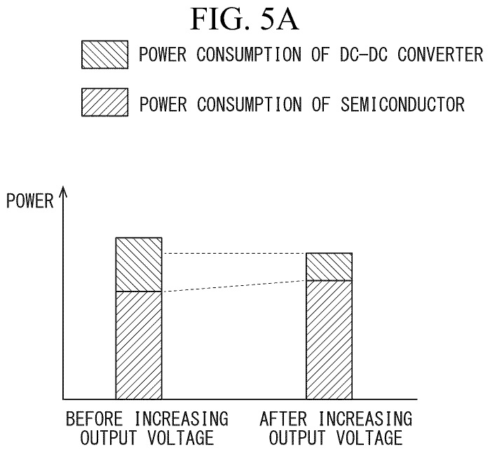

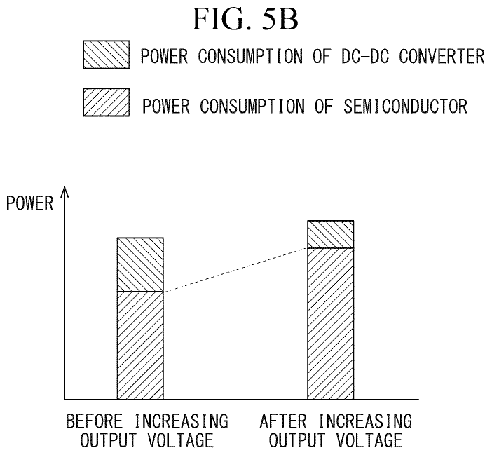

FIG. 5A and FIG. 5B are diagrams showing one example and another example of the total power consumption before and after increasing the voltage applied to the semiconductor during the transition to the power-saving mode. When the voltage applied to the semiconductor is increased in the power-saving mode, the power consumption generally tends to increase, but the amount of increased power varies depending on the process and circuit scale of the semiconductor used. FIG. 5A shows a case where the increase in power consumption of the semiconductor is small, and FIG. 5B shows a case where the increase in power consumption of the semiconductor is large. The power consumption of the DC-DC converter 32 is the same in both cases. In the case of FIG. 5A, since the total power consumption decreases at the time of transition to the power-saving mode, power reduction can be realized by the application of this embodiment. On the other hand, in the case of FIG. 5B, since the total power consumption increases at the time of transition to the power-saving mode, it is not necessary to apply the present embodiment. The present embodiment may be applied only to the load circuit 33 which is determined to be effective by a trial calculation of power or verification using an actual machine.

The power supply circuit 30 according to the embodiment described above includes the voltage adjusting part 34 which adjusts the output voltage V3 of the DC-DC converter 32 and the voltage monitoring part 35 which monitors the input voltage V1 of the DC-DC converter 32. The voltage adjusting part 34 increases the output voltage V3 when the input voltage V1 falls below the reference voltage at the time of transition from the normal mode to the power-saving mode. According to this configuration, the power supply circuit 30 can improve the conversion efficiency of the DC-DC converter 32 with a low-cost configuration.

According to the power supply circuit 30 according to the present embodiment, the voltage adjusting part 34 decreases the output voltage V3 when the input voltage V1 exceeds the reference voltage at the time of returning from the power-saving mode to the normal mode. According to this configuration, the power supply circuit 30 can improve the conversion efficiency of the DC-DC converter 32 with a low-cost configuration.

According to the power supply circuit 30 of the present embodiment, the voltage monitoring part 35 includes the comparator 41 which compares the input voltage V1 with the reference voltage. According to this configuration, the power supply circuit 30 can monitor the voltage with a low-cost configuration.

In the above embodiment, it is described that the load circuit 33 includes the motors for driving the charging device 12, the exposure device 13, the developing device 14, the intermediate transfer unit 15, the fixing device 7, and the conveying roller 17 as well as the control part 2. However, the load circuit 33 may be at least one of the motors for driving the charging device 12, the exposure device 13, the developing device 14, the intermediate transfer unit 15, the fixing device 7, or the conveying roller 17, or the control part 2.

In the above embodiment, it is described that the printing apparatus 1 which prints images using an electrophotographic method includes a load circuit 33. However, a printing apparatus which prints images using an inkjet method may also include a load circuit 33. In this case, the load circuit 33 may be at least one of a motor for driving conveying rollers, a conveying unit, or an image forming unit, or a control part, which are not shown. The conveying rollers are rollers which convey a sheet along a conveying path. The conveying unit is a unit which attracts and further conveys the sheet conveyed along the conveying path. The image forming unit is a unit which ejects ink onto the sheet conveyed by the conveying unit to form an image.

The load circuit 33 is not limited to the motors of the charging device 12 and the others, but may be any motor as long as it is a motor for operating the printing apparatus 1. The load circuit 33 is not limited to the control part 2 including, for example, a semiconductor which is a CPU, but may be any semiconductor as long as it is a semiconductor for controlling the printing apparatus 1.

In the above embodiment, it is described that the power-saving mode is a state in which the semiconductor provided in the printing apparatus 1 is not operating much. However, the power-saving mode may be a state of the printing apparatus 1 in which the power consumption of the printing apparatus 1 is lower than a predetermined power consumption. The normal mode may be a state of the printing apparatus 1 in which the power consumption of the printing apparatus 1 is equal to or larger than a predetermined power consumption.

According to these configurations, the printing apparatus 1 according to the present disclosure is configured to print on the sheet S. The printing apparatus 1 includes the load circuit 33 configured to control or operate the printing apparatus 1, and the power supply circuit 30 including the DC-DC converter 32 configured to output a voltage to the load circuit 33. The power supply circuit 30 further includes the voltage adjusting part 34 configured to adjust the output voltage V3 when the input voltage V1, which is the voltage input to the DC-DC converter 32, is lower than a predetermined reference voltage. In addition, the voltage adjusting part 34 is configured to adjust the output voltage V3 so that the voltage difference between the input voltage V1 and the output voltage V3, which is the voltage output from the DC-DC converter 32, is reduced compared to before the adjustment. Therefore, since the printing apparatus 1 reduces the voltage difference between the input voltage V1 and the output voltage V3, the conversion efficiency of the voltage by the DC-DC converter 32 can be improved compared to conventional methods.

According to these configurations, the printing apparatus 1 further includes the AC-DC converter 31 configured to input a voltage lower than the reference voltage to the DC-DC converter 32 when the mode control signal is input. The mode control signal indicates that the mode of the printing apparatus 1 is transited from the normal mode to the power-saving mode. The normal mode is a mode of the printing apparatus 1 in which the power consumption of the printing apparatus 1 is equal to or larger than a predetermined power consumption. The power-saving mode is a mode of the printing apparatus 1 in which the power consumption of the printing apparatus 1 is lower than the predetermined power consumption. Therefore, the printing apparatus 1 can reduce power consumed in the power-saving mode and the amount of power consumed per unit time compared to conventional methods.

According to these configurations, the voltage adjusting part 34 of the power supply circuit 30 is configured to adjust the output voltage V3 so that the voltage difference between the input voltage V1 and the output voltage V3 decreases by increasing the output voltage V3. Further, the power consumption of the load circuit 33 increases due to an increase in the output voltage V3, and the power consumption of the DC-DC converter 32 decreases due to a decrease in the voltage difference between the input voltage V1 and the output voltage V3. Further, the decreased power consumption is larger than the increased power consumption. The decreased power consumption is obtained by subtracting the power consumption of the DC-DC converter 32 after the decreasing from the power consumption of the DC-DC converter 32 before the decreasing. The increased power consumption is obtained by subtracting the power consumption of the load circuit 33 before the increasing from the power consumption of the load circuit 33 after the increasing. Therefore, the printing apparatus 1 can reduce the power consumption and the amount of power consumption per unit time compared to conventional methods.

According to these configurations, the load circuit 33 includes a semiconductor. Further, the increased power consumption generated by the increase in the output voltage V3 is caused by the increase in the leakage current generated in the semiconductor caused by the increase in the output voltage V3. Therefore, even when the control of the printing apparatus 1 becomes complicated and the semiconductors for controlling the printing apparatus 1 become larger in size or number, the printing apparatus 1 can suppress the increase in the power consumption and the amount of power consumption of the printing apparatus 1 compared to conventional methods.

While the disclosure has been described for specific embodiments, the disclosure is not limited to the above embodiments. The above embodiments can be modified by those skilled in the art without departing from the scope and spirit of the present disclosure.

### Appendix 1

A power supply circuit according to Appendix 1, comprising:
a voltage monitoring part configured to monitor an input voltage of a DC-DC (Direct Current-Direct Current) converter; and
a voltage adjusting part configured to adjust an output voltage of the DC-DC converter by increasing the output voltage of the DC-DC converter when the input voltage falls below a reference voltage at a time of transition from a normal mode to a power-saving mode.

### Appendix 2

A power supply circuit according to Appendix 2 is the power supply circuit according to Appendix 1, wherein
the voltage adjusting part is configured to decrease the output voltage when the input voltage exceeds the reference voltage at a time of returning from the power-saving mode to the normal mode.

### Appendix 3

A power supply circuit according to Appendix 3 is the power supply circuit according to Appendix 1 or 2, wherein
the voltage monitoring part includes a comparator configured to compare the input voltage with the reference voltage.

### Appendix 4

A printing apparatus according to Appendix 4 configured to print on a sheet, the printing apparatus comprising:
a load circuit configured to control or operate the printing apparatus, and
a power supply circuit including:
   a DC-DC (Direct Current-Direct Current) converter configured to output a voltage to the load circuit; and
   a voltage adjusting part configured to adjust an output voltage which is a voltage output from the DC-DC converter so that, when an input voltage which is a voltage input to the DC-DC converter is lower than a predetermined reference voltage, a voltage difference between the input voltage and the output voltage is reduced compared to before adjustment.

### Appendix 5

A printing apparatus according to Appendix 5 is the printing apparatus according to Appendix 4, further comprising an AC-DC (Alternating Current-Direct Current) converter configured to input a voltage lower than the reference voltage to the DC-DC converter when a signal indicating that a mode of the printing apparatus is transited from a normal mode to a power-saving mode is input, the normal mode being a mode in which a power consumption of the printing apparatus is equal to or larger than a predetermined power consumption, the power-saving mode being a mode in which the power consumption of the printing apparatus is lower than the predetermined power consumption.

### Appendix 6

A printing apparatus according to Appendix 6 is the printing apparatus according to Appendix 4 or 5, wherein
the voltage adjusting part is configured to adjust the output voltage so that the voltage difference decreases by increasing the output voltage,
a power consumption of the load circuit increases due to an increase of the output voltage,
a power consumption of the DC-DC converter decreases due to a decrease of the voltage difference, and
a decreased power consumption is larger than an increased power consumption, the decreased power consumption being obtained by subtracting the power consumption of the DC-DC converter after the decrease from the power consumption of the DC-DC converter before the decrease, the increased power consumption being obtained by subtracting the power consumption of the load circuit before the increase from the power consumption of the load circuit after the increase.

### Appendix 7

A printing apparatus according to Appendix 7 is the printing apparatus according to any one of Appendices 4 to 6, wherein
the load circuit includes a semiconductor, and
the increased power consumption generated by the increase in the output voltage is caused by the increase in a leakage current generated in the semiconductor caused by the increase in the output voltage.

1. A power supply circuit comprising:
a voltage monitoring part configured to monitor an input voltage of a DC-DC (Direct Current-Direct Current) converter; and
a voltage adjusting part configured to adjust an output voltage of the DC-DC converter by increasing the output voltage of the DC-DC converter when the input voltage falls below a reference voltage at a time of transition from a normal mode to a power-saving mode.

2. The power supply circuit according to claim 1, wherein
the voltage adjusting part is configured to decrease the output voltage when the input voltage exceeds the reference voltage at a time of returning from the power-saving mode to the normal mode.

3. The power supply circuit according to claim 1, wherein
the voltage monitoring part includes a comparator configured to compare the input voltage with the reference voltage.

4. A printing apparatus configured to print on a sheet, the printing apparatus comprising:
a load circuit configured to control or operate the printing apparatus, and
a power supply circuit including:
a DC-DC (Direct Current-Direct Current) converter configured to output a voltage to the load circuit; and
a voltage adjusting part configured to adjust an output voltage which is a voltage output from the DC-DC converter so that, when an input voltage which is a voltage input to the DC-DC converter is lower than a predetermined reference voltage, a voltage difference between the input voltage and the output voltage is reduced compared to before adjustment.

5. The printing apparatus according to claim 4, further comprising an AC-DC (Alternating Current-Direct Current) converter configured to input a voltage lower than the reference voltage to the DC-DC converter when a signal indicating that a mode of the printing apparatus is transited from a normal mode to a power-saving mode is input, the normal mode being a mode in which a power consumption of the printing apparatus is equal to or larger than a predetermined power consumption, the power-saving mode being a mode in which the power consumption of the printing apparatus is lower than the predetermined power consumption.

6. The printing apparatus according to claim 5, wherein
the voltage adjusting part is configured to adjust the output voltage so that the voltage difference decreases by increasing the output voltage,
a power consumption of the load circuit increases due to an increase of the output voltage,
a power consumption of the DC-DC converter decreases due to a decrease of the voltage difference, and
a decreased power consumption is larger than an increased power consumption, the decreased power consumption being obtained by subtracting the power consumption of the DC-DC converter after the decrease from the power consumption of the DC-DC converter before the decrease, the increased power consumption being obtained by subtracting the power consumption of the load circuit before the increase from the power consumption of the load circuit after the increase.

7. The printing apparatus according to claim 6, wherein
the load circuit includes a semiconductor, and
the increased power consumption generated by the increase in the output voltage is caused by the increase in a leakage current generated in the semiconductor caused by the increase in the output voltage.
